(19) United States
(12) Patent Application Publication
(10) Pub. No.: US 2003/0210382 A1
(43) Pub. Date: Nov. 13, 2003

(54) Matrix light relay system and method

(75) Inventors: Takashi Kanatake, Torokozawa-shi (JP); Takashi Mukai, Anan-shi (JP)

Correspondence Address: HAYNES AND BOONE, LLP, 901 MAIN STREET, SUITE 3100, DALLAS, TX, 75202, US

(73) Assignee: Ball Semiconductor, Inc., Allen, TX (US)

(21) Appl. No.: 10/418,498

(22) Filed: Apr. 18, 2003

Related U.S. Application Data
(60) Provisional application No. 60/319,193, filed on Apr. 19, 2002.

(51) Int. Cl. G03B 27/48

(52) U.S. Cl. 355/51

(57) ABSTRACT

A system and method for an imaging system is provided. The system utilizes light of at least two wavelengths to project an image. The image is first projected using light of a first wavelength from a device such as a cathode ray tube and is directed towards a diode array connectable to an integrated circuit (IC). The light may pass through a translucent substrate of the diode array and strike sensors associated with the diodes and connected to the IC. Sensors which receive the light may provide power to the associated diodes using a power circuit present on the IC. The diodes receiving power may then emit light of the second wavelength and the emitted light may pass back through the translucent substrate. The IC may provide amplification if desired.

### CROSS REFERENCE

This application claims priority to U.S. Provisional Patent Application Serial No. 60/319,193, filed on Apr. 19, 2002.

### BACKGROUND

The present disclosure relates generally to imaging systems, and more particularly, to a system and method for controllably projecting light during photolithography.

Imaging systems frequently utilize one or more light sources during scanning processes. For example, a photolithography system may use a light source such as a mercury lamp to project an image onto a substrate. Within the photolithography system, light projected by the light source may be directed by a pixel panel or other image-creating device to control the path of the light.

Limitations in an imaging system may be introduced by the components which form the imaging system, such as the light source and the pixel panel described above. The light source should be able to provide light of a predetermined wavelength and intensity, but may be limited by such factors as power consumption, heat dissipation, and similar issues that limit the light source's ability to produce light of the desired intensity. The pixel panel should be able to properly redirect the light projected by the light source towards a subject, but may be limited by such factors as the amount of area available for control and power lines and the transition time from one state to another (e.g., the physical movement of a mirror from a position where it does not direct light towards the subject to a position where it does direct light towards the subject and vice versa). Both the light source and the pixel panel may affect the resolution of the imaging system, which determines the amount of information that can be imaged onto a given area of the subject.

Accordingly, certain improvements are desired for imaging systems. For one, it is desirable to provide a light source that produces light of a desired intensity. In addition, it is desired to have provide a relatively high resolution, a relatively large exposure area, to provide good redundancy, to provide high light energy efficiency, to provide high productivity and resolution, and to be more flexible and reliable.

### SUMMARY

A technical advance is provided by a novel system and method for projecting light onto a subject. In one embodiment, the system includes a first light source that can emanate light of a first wavelength and a first sensor operable to receive light of the first wavelength. A power supply circuit is responsive to the first sensor and may provide power when the first sensor receives light of the first wavelength. A second light source is associated with the first sensor and accessible to the power supply circuit, and may emanate light of a second wavelength in response to receiving power from the power supply circuit.

In another embodiment, the system includes a light source operable to emanate light of a first wavelength and an integrated circuit connectable to the light source. The integrated circuit includes a power supply circuit operable to provide power from a power supply to the light source and a photo sensor associated with the light source and accessible to the power supply. The photo sensor may receive light of a second wavelength and provide power to the light source through the power supply circuit in response to receiving the light of the second wavelength, so that the light source can emanate light of the first wavelength.

In yet another embodiment, the system includes a diode array. The diode array includes a diode and has a translucent substrate, so that light of the second wavelength passes through the translucent substrate to be received by the photo sensor and light emanated from the diode passes through the translucent substrate.

### BRIEF DESCRIPTION OF THE DRAWINGS

FIG. 1 is a diagrammatic view of an improved digital photolithography system for implementing various embodiments of the present invention.

FIG. 2 illustrates an exemplary point array aligned with a subject.

FIG. 3 illustrates the point array of FIG. 2 after being rotated relative to the subject.

FIG. 4 illustrates a laser diode array that may be used in the system of FIG. 1.

FIG. 5 illustrates an exemplary imaging system that receives light and projects the light on to a substrate.

FIG. 6 illustrates a multi-layered “window” that may be used in the system of FIG. 5.

FIG. 7 illustrates an integrated circuit that may include a plurality of the windows of FIG. 6.

FIG. 8 illustrates one embodiment of a portion of the system of FIG. 5.

FIG. 9 illustrates a light relay system.

FIG. 10 is a flowchart of a method that may be practiced on the systems of FIGS. 5 and 9.

### DETAILED DESCRIPTION

The present disclosure relates to imaging systems, and more particularly, to a system and method for controllably projecting and redirecting light during photolithography. It is understood, however, that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Referring now to FIG. 1, a maskless photolithography system 100 is one example of a system that can benefit from the present invention. In the present example, the maskless photolithography system 100 includes a light source 102, a first lens system 104, a computer aided pattern design system 106, a pixel panel 108, a panel alignment stage 110, a second lens system 112, a subject 114, and a subject stage 116. A resist layer or coating 118 may be disposed on the subject 114. The light source 102 may be an incoherent light source (e.g., a Mercury lamp) that provides a collimated beam of light 120 which is projected through the first lens system 104 and onto the pixel panel 108. Alternatively, the light source 102 may be an array comprising, for example, laser diodes or light emitting diodes (LEDs) that are individually controllable to project light.

The pixel panel 108, which may be a digital mirror device (DMD), is provided with digital data via suitable signal line(s) 128 from the computer aided pattern design system 106 to create a desired pixel pattern (the pixel-mask pattern). The pixel-mask pattern may be available and resident at the pixel panel 108 for a desired, specific duration. Light emanating from (or through) the pixel-mask pattern of the pixel panel 108 then passes through the second lens system 112 and onto the subject 114. In this manner, the pixel-mask pattern is projected onto the resist coating 118 of the subject 114.

The computer aided mask design system 106 can be used for the creation of the digital data for the pixel-mask pattern. The computer aided pattern design system 106 may include computer aided design (CAD) software similar to that which is currently used for the creation of mask data for use in the manufacture of a conventional printed mask. Any modifications and/or changes required in the pixel-mask pattern can be made using the computer aided pattern design system 106. Therefore, any given pixel-mask pattern can be changed, as needed, almost instantly with the use of an appropriate instruction from the computer aided pattern design system 106. The computer aided mask design system 106 can also be used for adjusting a scale of the image or for correcting image distortion.

In some embodiments, the computer aided mask design system 106 is connected to a first motor 122 for moving the stage 116, and a driver 124 for providing digital data to the pixel panel 108. In some embodiments, an additional motor 126 may be included for moving the pixel panel. The system 106 can thereby control the data provided to the pixel panel 108 in conjunction with the relative movement between the pixel panel 108 and the subject 114.

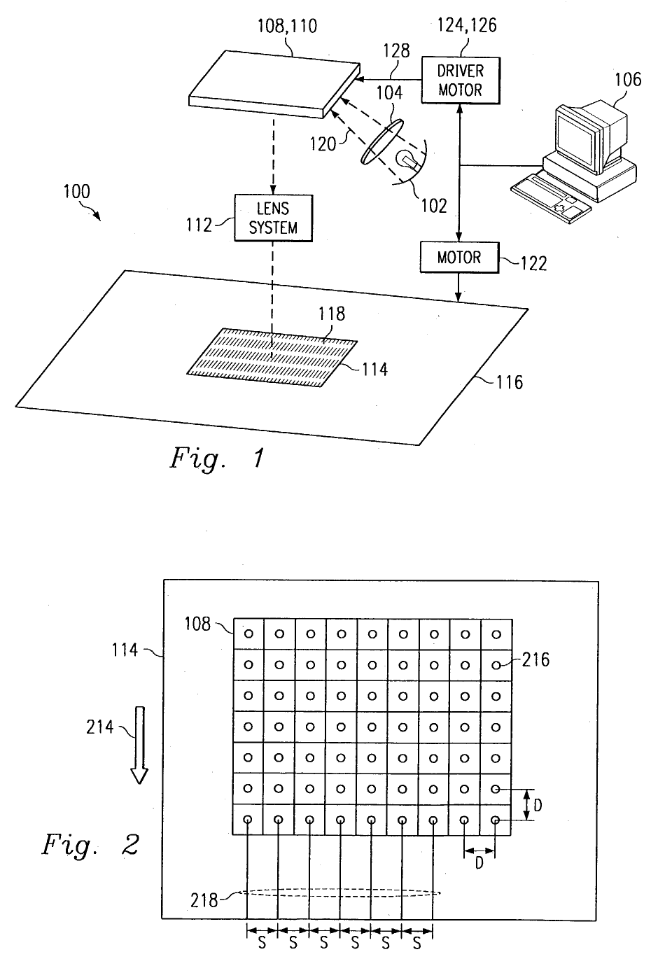

Referring now to FIG. 2, the pixel panel 108 (comprising a DMD) of FIG. 1 is illustrated. The pixel panel 108 described in relation to FIG. 1 has a limited resolution which depends on such factors as the distance between pixels, the size of the pixels, and so on. However, higher resolution may be desired and may be achieved as described below. The pixel panel 108, which is shown as a point array for purposes of clarification, projects an image (not shown) upon the subject 114, which may be a substrate. The substrate 114 is moving in a direction indicated by an arrow 214. Alternatively, the point array 108 could be in motion while the substrate 114 is stationary, or both the substrate 114 and the point array 108 could be moving simultaneously. The point array 108 is aligned with both the substrate 114 and the direction of movement 214 as shown. A distance, denoted for purposes of illustration as “D”, separates individual points 216 of the point array 108. In the present illustration, the point distribution that is projected onto the subject 114 is uniform, which means that each point 216 is separated from each adjacent point 216 both vertically and horizontally by the distance D.

As the substrate 114 moves in the direction 214, a series of scan lines 218 indicate where the points 216 may be projected onto the substrate 114. The scan lines are separated by a distance “S”. Because of the alignment of the point array 108 with the substrate 114 and the scanning direction 214, the distance S between the scan lines 218 equals the distance D between the points 216. In addition, both S and D remain relatively constant during the scanning process. Achieving a higher resolution using this alignment typically requires that the point array 108 embodying the DMD be constructed so that the points 216 are closer together. Therefore, the construction of the point array 108 and its alignment in relation to the substrate 114 limits the resolution which may be achieved.

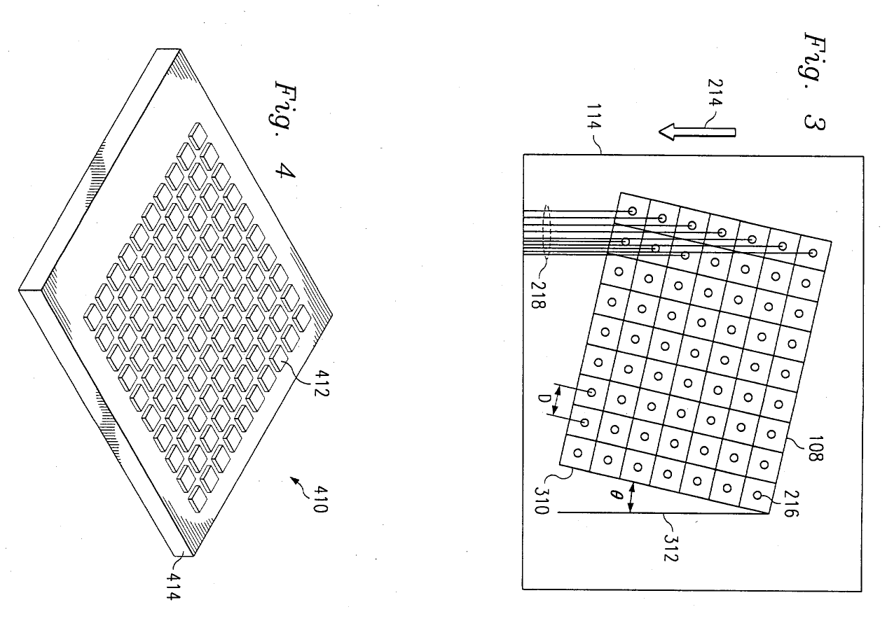

Referring now to FIG. 3, a higher resolution may be achieved with the point array 108 of FIG. 2 by rotating the DMD embodying the point array 108 in relation to the substrate 114. The rotation is identified by an angle between an axis 310 of the rotated point array 108 and a corresponding axis 312 of the substrate. As illustrated in FIG. 3, although the distance D between the points 216 remains constant, such a rotation may reduce the distance S between the scan lines 218, which effectively increases the resolution of the point array 108. The image data that is to be projected by the point array 108 must be manipulated so as to account for the rotation of the point array 108.

The magnitude of the angle may be altered to vary the distance S between the scan lines 218. If the angle is relatively small, the resolution increase may be minimal as the points 216 will remain in an alignment approximately equal to the alignment illustrated in FIG. 2. As the angle increases, the alignment of the points 216 relative to the substrate 114 will increasingly resemble that illustrated in FIG. 3. If the angle is increased to certain magnitudes, various points 216 will be aligned in a redundant manner and so fall onto the same scan line 218. Therefore, manipulation of the angle permits manipulation of the distance S between the scan lines 218, which affects the resolution of the point array 108. It is noted that the distance S may not be the same between different pairs of scan lines as the angle is altered.

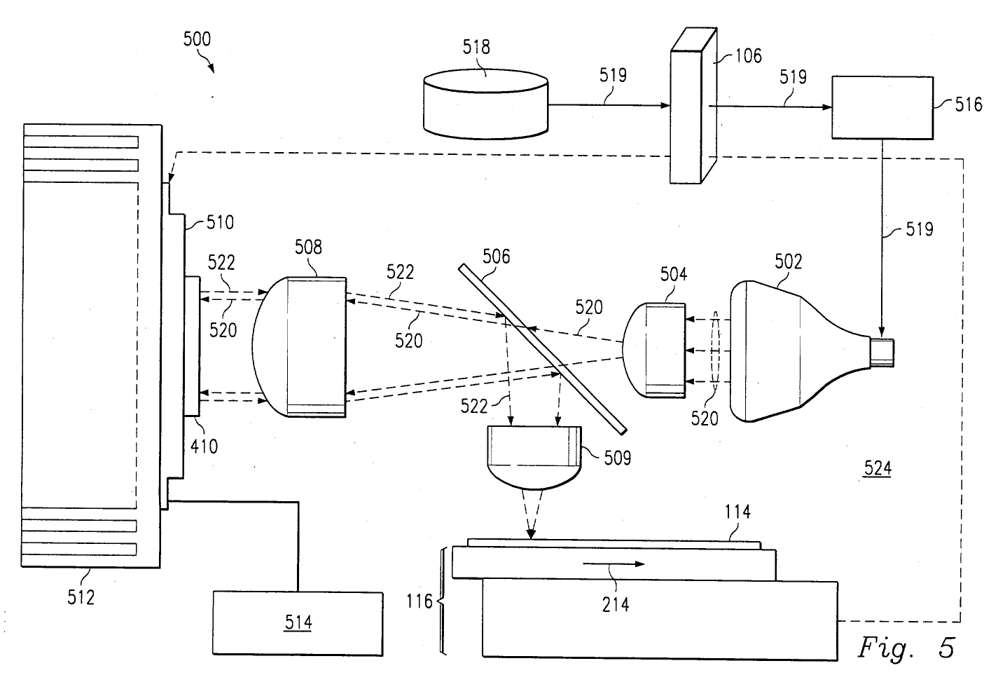

Referring now to FIG. 4, in another embodiment, the conventional light source 102 of FIG. 1 may be replaced by a diode array 410, which may be an array of LEDs or laser diodes (both of which are hereinafter referred to as a laser diode array for purposes of clarity). The laser diode array 410 may comprise a plurality of laser diodes 412 embedded within or connectable to a substrate 414. The substrate 414 may be relatively translucent and so may enable light to pass through the substrate 414. The translucency may depend on the thinness of the substrate and/or the material of which it is made. For example, the substrate 414 may be made of a material such as sapphire to enhance the translucency of the substrate 414. In the present example, each laser diode 412 may be positioned relative to the substrate 414 so that light projected by the laser diodes 412 passes through, rather than away from, the substrate 414.

In operation, each laser diode 412 may be turned on and off by controlling the power supplied to each laser diode 412. The individual laser diodes 412 may be controlled by signal and/or power lines to either project light or not project light (e.g., be “on” or “off”) onto the pixel panel 108. Alternatively, the laser diode array 410 may project light directly onto the substrate 114 of FIG. 1, replacing the pixel panel 108. A variety of arrangements of the laser diode array 410 in the system 100 of FIG. 1 are illustrated in greater detail in U.S. patent application Ser. No. 09/820,030, filed on Mar. 28, 2001, and also assigned to Ball Semiconductor, Inc., entitled “INTEGRATED LASER DIODE ARRAY AND APPLICATIONS” and hereby incorporated by reference as if reproduced in its entirety.

Referring now to FIG. 5, in another embodiment, an imaging system 500 may replace some or all of the components of the photolithography system 100 of FIG. 1. The system 500 is operable to project an image produced by a light source 502 onto the substrate 114 with sufficient intensity for photolithography using the diode array 410 of FIG. 4. In the present example, the imaging system 500 includes the light source 502, which may be a cathode ray tube (CRT), a first lens 504, a mirror 506, a second lens 508, a third lens 509, the diode array 410, an integrated circuit (IC) 510, which may be a power IC capable of amplifying a signal, a cooling device 512, and a power supply 514. The computer 106 may control the CRT 502 using a driver 516. Data for the system 500 may be obtained from a database 518 that is accessible to the computer 106, and may follow a path indicated by arrows 519.

In operation, the computer 106 sends data via the path 519 to the CRT 502, which may be capable of projecting a relatively large amount of image data. The image (represented by the light beams 520) projected by the CRT 502 passes through the lens 504, which may be single lens or a lens system comprising a variety of optical components. For example, the lens 504 may comprise one or more lenses, optical gratings, microlens arrays, and/or other optical devices to aid in passing the image projected by the CRT 502 to the mirror 506. In the present example, the lens 504 is mono-directional and directs the light 520 projected by the CRT 502 onto the mirror 506. The mirror 506 may be an ultraviolet (UV) light mirror designed to allow the light 520 to pass from the lens 504 through to the lens 508, but not allow the light 522 to pass from the lens 508 to the lens 504. Rather, the light 522 may be reflected by the mirror 506 towards the subject 114.

The lens 508, which may be a bi-directional lens system, directs the image onto the diode array 410. The structure and operation of the diode array 410 and the IC 510 will be discussed later in greater detail, and so will be summarized while describing the operation of the system 500. The IC 510, in response to the projection of the light 520 through the diode array 410 and onto the IC 510, may provide power to various diodes 412 of the diode array 410 corresponding to locations on the IC 510 that receive the light 520. The IC 510 may also provide amplification, so that, for example, the received light 520 is intensified.

The diode array 410, in response to the projection of the image onto the diode array 410 and the IC 510 by the lens 508, may project a plurality of laser beams 522 representing the image onto the lens 508. The laser beams 522 may be of a different wavelength than the light 520. The length of time during which the laser beams 522 are projected by the laser diode array 410 may be controlled. For example, a duration setting may be used to define a length of time that the laser beams 522 are to be projected. Accordingly, the length of time that the image is projected by the CRT 502 may differ from the length of time that the laser diode array 410 projects the laser beams 522. The laser beams 522 pass through the lens 508 and are directed by the mirror 506 onto the lens 509, which in turn projects the beams 522 onto the substrate 114. The operation of the system 500 may also include data sent from the stage 116 to the computer 106, as indicated by an arrow 524. The data may, for example, aid in synchronizing the motion of the substrate 114 with the projection of the laser beams 522 (e.g., the duration of the laser beams 522, etc.).

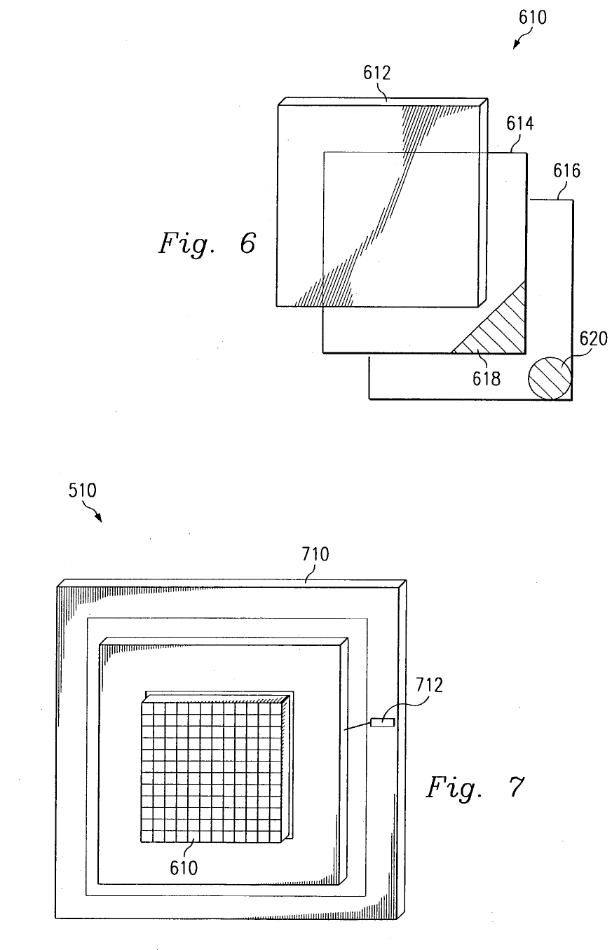

Referring now to FIG. 6, portions of the diode array 410 and the IC 510 may be divided into a “window” 610 comprising a diode array layer 612, a bumping layer 614, and a power layer 616. The bumping layer 614 and the power layer 616 may be formed on the IC 510, while the diode array layer 612 may be connected to the power layer 616 by the bumping layer 614. In the present example, the window 610 represents a discrete unit that includes a single diode 412 and supporting circuitry formed on the IC 510. It is noted that the various layers 612-616 may be combined or further divided as desired, and that a plurality of windows may be formed using such layers. For purposes of clarity, only the single window 610 will be described.

The diode array layer 612 comprises a portion of the diode array 410, such as a single laser diode 412 (not shown). As previously described, the substrate 414 forming the laser diode array 410 is relatively thin and enables light to pass through the substrate 414. The diode array layer 612 may be positioned relative to the bumping layer 614 and power layer 616 so that the laser diode 412 will project light away from the layers 614 and 616 when turned on.

The bumping layer 614 provides a surface by which the diode array layer 612 may be attached to the IC 510. The bumping layer may be opaque but, for reasons which will be described more fully below, should allow light to pass through to at least a portion of the power layer 614. This may be accomplished by providing a relatively translucent window 618 in the bumping layer 614. It is noted that the window 618 may be an area where no bumping material is present.

The power layer 616 includes circuitry (not shown) that is operable to provide power to the laser diode 412 of the diode array layer 612. The power layer includes a sensor 620, which may receive light through the window 618 of the bumping layer 614. Accordingly, the location of the sensor 620 and the location of the window 618 should correspond to similar locations on their respective layers 616 and 614. The power layer 616 may be constructed so that it provides power to the laser diode 412 of the diode array layer 612 when the sensor 620 receives light through the window 618. The sensor 620 may be designed so as to sense a predefined wavelength of light or may be responsive to light of multiple wavelengths.

Referring now to FIG. 7, the window 610 of FIG. 6 may be a single window in the IC 510 of FIG. 5. The IC 510 may comprise a substrate 710, upon which the bumping layer 614 (not shown) and the power layer 616 (not shown) may be formed. One or more power connectors 712 may be connected to the power layer 616 via the IC 510. The power connector 712 may provide a common power source for the power layer 616. Accordingly, a separate power connector 712 may not exist for each laser diode (as will be illustrated below). For example, a single power connector 712 may supply all the laser diodes 412 associated with the IC 510, or a predefined number of laser diodes 412 may use the power supplied via a single power connector 712.

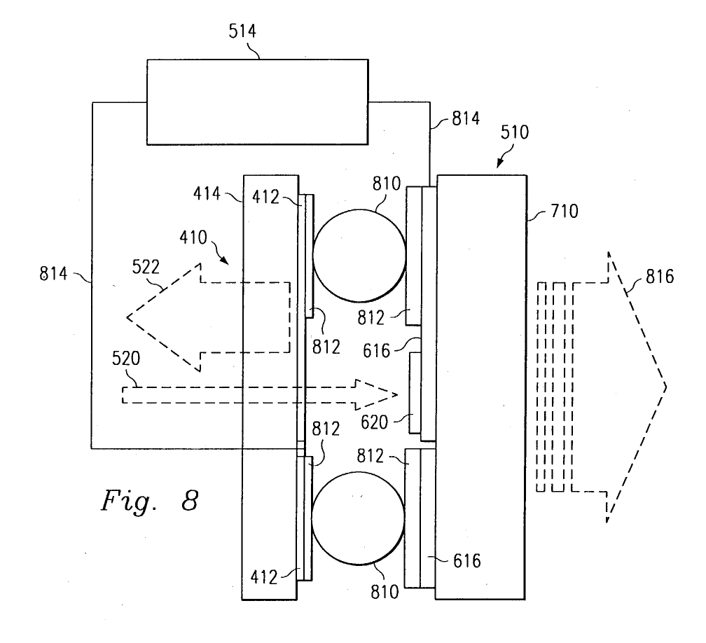

Referring now to FIG. 8, in another embodiment, the diode array 410 and the IC 510 may be joined using one or more bumping balls 810 to connect bumping pads 812 that may be present on the diode array 410 and the IC 510. In the present example, the bumping balls 810 may represent the bumping layer 614 of FIG. 6, which is not otherwise shown. The bumping ball 810 provides a power connection between each laser diode 412 associated with each bumping ball 810 and the power layer 616 of the IC 510.

In operation, light 520 projected by the CRT 502 of FIG. 5 passes through the translucent substrate 414 of the laser diode array 410. Although the bumping layer 614 is represented only by the bumping ball 810 in the present example, the light 520 may pass through the previously described window 618 of the bumping layer 614. The light 520 then strikes the sensor 620 of the power layer 616. The sensor 620, upon detecting the light 520, provides power from the power layer 616 to the laser diode 412 via the bumping ball 810. The IC 510 may provide amplification of the light 520, so that a relatively weak signal may be used to trigger a much stronger signal that is projected from the laser diode 412. For example, the IC 510 may provide a gain of sixty decibels.

The laser diode 412 projects laser beams 522 through the translucent substrate 414. It is noted that the light 520 and the laser beams 522 may be of different wavelengths to avoid problems such as interference that may arise if the same wavelength is used. For example, the sensor 620 may sense light having a visible spectrum wavelength of red or longer, while the laser diode 410 may emit light having a visible wavelength of blue or shorter. In the current example, the laser diode 410 may emit ultraviolet light of 405 nanometers or less. The duration during which the laser beams 522 are projected may be controlled using a duration time setting.

In the present example, the laser diode 412 may share a common electrical ground with other laser diodes 412 of the laser diode array 410. This common ground may be combined with the common power supply 514 providing power to each laser diode 412 through the power layer 616 to simplify power delivery to the laser diodes 412. Accordingly, rather than each laser diode 412 using a separate power line and/or control line accessible via the substrate 710, each laser diode 412 may utilize the common power supply and ground, which may be controlled by the sensor 620 associated with each laser diode 412. The power supply 514 may provide power through power lines 814.

Heat may be dissipated from the laser diode 412 through the bumping ball 810 and the power IC 510 as indicated by the arrow 816. In some embodiments, a cooling device (such as the cooling device 512 of FIG. 5) may be proximate to the IC 510 to assist in heat dissipation.

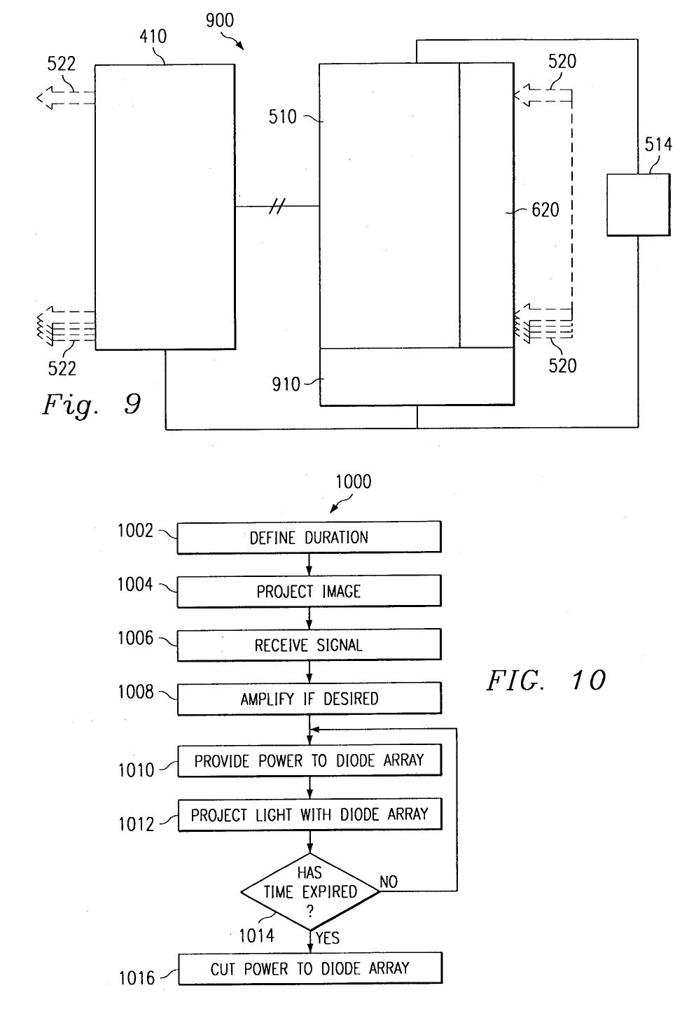

Referring now to FIG. 9, in another embodiment, a light relay system 900 may convert light from one wavelength to another wavelength. Sensors 620, which may be photo sensors, receive input signals comprising light 520 of a particular wavelength or wavelengths. It is noted that each sensor 620 may be designed to detect light of one or more wavelengths, and the neighboring sensors 620 may be designed to detect light of other wavelengths. The sensors 620 are connected to an IC 510, which may amplify the light signals 520 received by the sensors 620. Additionally, each sensor 620 may be associated with a particular laser diode 412 of a laser diode array 410. A DC power supply 514 provides power to the IC 510 and may share a common ground with the laser diode array 410 and a common gate controller 910.

In operation, the controller 910 may provide power to the IC 510 by setting a “GO” flag, opening the gate to the IC 510. After a predefined amount of time expires, the controller 910 may cut off the power to the IC 510 by setting a “RESET” flag. In this manner, the controller 910 may control the output of light 522 from the laser diode array 410 according to when signals are received by the sensors 620. Accordingly, light 520 may be received by the system 900, amplified if desired, and relayed as light 522 of a different wavelength while retaining desirable aspects of the received light 520. For example, if an image is received by the system 900, then the same image may be relayed using light of greater intensity and/or different wavelengths.

Referring now to FIG. 10, in another embodiment, a method 1000 illustrates a number of steps 1002-1016 that may occur in various embodiments described previously. In step 1002, an amount of time is defined for which the laser diode array 410 is to be activated. Light, which may form an image, is projected in step 1004. The sensors 620 receive the projected light as signals in step 1006. The signals may be amplified in step 1008, and power is provided to individual laser diodes 412 of the laser diode array 410 via the IC 510 in step 1010. As described in reference to FIG. 9, the power may be controlled by a controller 910. It is noted that only laser diodes 412 associated with sensors 620 that have received a signal may receive power, although other power arrangements may be desirable. The power enables the laser diodes 412 to project light in step 1012. As described previously, the light projected by the laser diodes 412 may be of a different wavelength than light received by the sensors 620.

In step 1014, the method 1000 may determine whether the amount of time defined in step 1002 has expired. If the time has expired, then the method continues to step 1016, where the controller 910 cuts off the power to the IC 510. If the time has not expired, the method returns to step 1010, where power is provided to the laser diodes 412.

While the invention has been particularly shown and described with reference to the preferred embodiment thereof, it will be understood by those skilled in the art that various changes in form and detail may be made therein without departing from the spirit and scope of the invention. For example, it is within the scope of the present invention to use an initial light source other than a cathode ray tube. Also, any number of wavelengths may be used simultaneously. Furthermore, the integrated circuit may include circuitry that enables a variety of other functions. Therefore, the claims should be interpreted in a broad manner, consistent with the present invention.

What is claimed is:

1. A system for projecting light onto a subject, the system comprising:
a first light source operable to emanate light of a first wavelength;
a first sensor operable to receive light of the first wavelength;
a power supply circuit responsive to the first sensor and operable to provide power when the first sensor receives light of the first wavelength; and
a second light source associated with the first sensor and accessible to the power supply circuit, the second light source operable to emanate light of a second wavelength in response to receiving power from the power supply circuit.

2. The system of claim 1 further including:
a second sensor operable to receive light of the first wavelength and to direct the power supply to provide power; and
a third light source associated with the second sensor and accessible to the power supply circuit, the third light source operable to emanate light of the second wavelength in response to receiving power from the power supply circuit.

3. The system of claim 2 wherein the power supply circuit is common to the second and third light sources and wherein the second and third light sources share a common electrical ground.

4. The system of claim 2 wherein the second and third light sources are diodes.

5. The system of claim 4 wherein the second and third light sources are selected from the group consisting of a laser diode and a light emitting diode.

6. The system of claim 4 wherein the second and third light sources emit ultraviolet light of 405 nanometers or less.

7. The system of claim 1 wherein the first light source is a cathode ray tube.

8. The system of claim 1 wherein the first light source includes at least one pixel panel.

9. The system of claim 1 further including:
a first lens and a second lens; and
a mirror, the mirror operable to direct light from the first lens onto the second lens and to direct light from the second lens towards the subject.

10. A system for relaying light, the system comprising:
a light source operable to emanate light of a first wavelength; and
an integrated circuit connectable to the light source, the integrated circuit comprising:
a power supply circuit operable to provide power from a power supply to the light source; and
a photo sensor associated with the light source and accessible to the power supply, the photo sensor operable to receive light of a second wavelength and provide power to the light source through the power supply circuit in response to receiving the light of the second wavelength, so that the light source can emanate light of the first wavelength.

11. The system of claim 10 further including a bumping layer, the bumping layer operable to connect the light source to the integrated circuit.

12. The system of claim 10 wherein the light source is a diode.

13. The system of claim 12 further including a diode array, the diode array including the diode and having a translucent substrate, so that light of the second wavelength passes through the translucent substrate to be received by the photo sensor and light emanated from the diode passes through the translucent substrate.

14. The system of claim 10 wherein the integrated circuit amplifies the received light of the second wavelength, so that the light of the first wavelength emanated by the light source is more intense than the received light of the second wavelength.

15. The system of claim 10 further including a cathode ray tube operable to project light of the second wavelength.

16. The system of claim 10 further including:
a first lens and a second lens; and
a mirror, the mirror operable to direct light from the first lens onto the second lens and to direct light from the second lens towards a subject.

17. The system of claim 10 further including a timer operable to control a duration during which the light source emanates light.

18. A method for converting an image from light of a first wavelength into light of a second wavelength, the method comprising:
projecting the image using light of the first wavelength;
receiving the image on a plurality of sensors accessible to a power supply circuit; and
providing power to a plurality of light sources associated with the sensors in response to receiving the image on the sensors, each light source operable to project light of the second wavelength in response to the provided power.

19. The method of claim 18 further including:
defining a length of time during which the light sources are to project light of the second wavelength; and
cutting off power to the light sources when the length of time has expired.

20. The method of claim 18 further including amplifying the received light of the first wavelength, so that the projected light of the second wavelength is more intense than the received light of the first wavelength.

21. The method of claim 18 further including providing a translucent substrate proximate to the light sources, so that light of the second wavelength passes through the translucent substrate to be received by the sensors and light emanated from the light sources passes through the translucent substrate.
